(19) United States
(12) Patent Application Publication
(10) Pub. No.: US 2025/0252034 A1
(43) Pub. Date: Aug. 7, 2025

(54) MULTI-LEVEL RECORD AND REPLAY OF JAVA APPLICATIONS

(71) Applicant: Oracle International Corporation, Redwood Shores, CA (US)

(72) Inventors: Arber Kuci, Zurich (CH); Hugo Guiroux, Zurich (CH); Bence Czipo, Alter Zurichweg (CH); Jonathan Lamperth, Zurich (CH)

(21) Appl. No.: 18/670,954

(22) Filed: May 22, 2024

Related U.S. Application Data
(60) Provisional application No. 63/550,104, filed on Feb. 6, 2024.

(51) Int. Cl. G06F 11/36; G06F 9/455

(52) U.S. Cl. CPC G06F 11/3636; G06F 9/45504

(57) ABSTRACT

Here is accelerated debug of more accurate replay of recorded Java execution. Nondeterministic execution, arguments, results, and side effects of subroutines are recorded by instrumentation at various architectural levels for increased accuracy of instrumented replay. In an embodiment, a computer configures for nondeterminism recording all of: a recorded subroutine, a native subroutine that is not a Java method, and a Java method that invokes the native subroutine. The native subroutine is invoked by invoking the Java method. For the native subroutine, instrumentation detects that the Java method already has activated nondeterminism recording. After the Java method finishes, the recorded subroutine is invoked. For the recorded subroutine, instrumentation detects that nondeterminism recording is inactive and should be activated.

### BENEFIT CLAIM

This application claims the benefit under 35 U.S.C. § 119 (c) of provisional application 63/550,104, filed Feb. 6, 2024, by Arber Kuci et al., the entire contents of which is hereby incorporated by reference. The applicant hereby rescinds any disclaimer of claim scope in the parent applications or the prosecution history thereof and advise the USPTO that the claims in this application may be broader than any claim in the parent application.

### FIELD OF THE DISCLOSURE

This disclosure relates to debug of replay of recorded Java execution. For increased accuracy of instrumented replay, nondeterministic execution, arguments, results, and side effects of subroutines are recorded by instrumentation at various architectural levels.

### BACKGROUND

Although somewhat common in production environments, sporadic malfunctions are difficult to reproduce (i.e. repeat) in a laboratory during debugging. Manually configuring to inject or otherwise cause a particular malfunction can be slow and prone to human error. One solution to reduce developer involvement is the record and replay debugging approach that can (e.g. inaccurately, incompletely) reproduce such bugs through recording the application execution that experienced a malfunction. Existing solutions suffer either from a) high recording overhead in time and space and are not suitable to be always-on in production or b) inaccurate replay. Accurate recording requires to capture all sources of nondeterminism which stem from interacting with the operating system through system calls. Recording at that level is a fine-grained mechanism, and the high frequency of system calls that an application issues and the amount of information to record for each system call leads to high recording overhead.

State of the art recording is slow and consumes too much space. State of the art replay is inaccurate (i.e. low fidelity reproduction), which may fail to recreate a malfunction. If a malfunction cannot be recreated, then debugging a software defect may be more or less ineffective, which increases the duration in which a malfunction may occur while the defect remains unrepaired. This decreases the reliability of the production computer. Unlike the state of the art, the technologic solution herein provides more accurate replay of a software execution, which accelerates malfunction recreation and decreases a time to repair a software defect.

### BRIEF DESCRIPTION OF THE DRAWINGS

In the drawings:

FIG. 1 is a block diagram that depicts an example computer for debug of replay of execution of subroutines as recorded in a Java virtual machine (JVM);

FIG. 2 is a flow diagram that depicts an example instrumenting process that a computer may perform for preparatory instrumenting that may occur at the beginning of either a recording phase or a replay phase;

FIG. 3 is a flow diagram that depicts an example recording process that a recording JVM may perform to generate a nondeterminism recorded log;

FIG. 4 is a flow diagram that depicts an example replay process that a replay JVM may perform based on a nondeterminism recorded log;

FIG. 5 is a block diagram that illustrates a computer system upon which an embodiment of the invention may be implemented;

FIG. 6 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here is accelerated debug of more accurate replay of recorded Java execution. Nondeterministic execution, arguments, results, and side effects of subroutines are recorded by instrumentation at various architectural levels for increased accuracy of instrumented replay. Low-latency recording and high-fidelity replay debugging herein is a technique of recording an execution of an application at runtime such that the application can be accurately replayed afterwards. To be able to replay an application, sources of nondeterminism such as inputs to the application received from a file or communication network should be recorded at runtime. The execution can be replayed by rerunning the application and ensuring that all points of nondeterminism are constrained by the information that was stored when recording the application. By recording sources of nondeterminism, an application can be replayed in a deterministic manner using the recorded information. This technique increases the speed and accuracy of reproducing and troubleshooting a bug (i.e. software defect). Herein, Java and JAVA are synonyms, and Java is a registered trademark owned by Oracle America Inc.

Recording the necessary information to be able to deterministically replay can introduce a significant performance overhead. By recording different sources of nondeterminism at different architectural levels of generalization, the approach herein does not have to sacrificially tradeoff between recording efficiency and replay accuracy. Here is a new way to record nondeterminism and replay an execution, which facilitates the debugging of Java applications. Recording overhead (i.e. latency) is decreased so that recording does not alter application behavior during recording. This approach records at a contextually best architectural level of multiple levels, minimizing the overhead of capturing execution information. For example, recording may occur at the Java hypertext transfer protocol (HTTP) application programing interface (API) layer instead of individual operating system (OS) system calls.

The goal of this approach is to record nondeterminism visible to a Java application using a multilevel approach where different sources of nondeterminism are recorded at different levels. The focus on Java is driven by the fact that, within the Java context, various simplifying assumptions about sources of nondeterminism can be made. In contrast to previous, more general solutions like a kernel-level record and replay approach, the approach herein can optimize for efficiency by utilizing Java runtime environment (JRE) and Java virtual machine (JVM) generalizations. This approach employs a multilevel strategy, utilizing Java generalizations at each level of recording. Two generalization levels (i.e. architectural layers in a software infrastructure stack) herein are the Java application programing interface (API) and OS system calls.

At the higher level, core Java APIs are enhanced in a novel way with a nondeterminism record and replay mechanism, and at the lower level is a novel JVM tool interface (JVMTI) agent to record nondeterminism. To understand the benefit of the multilevel approach, it is important to realize that recording at a higher level is more efficient (i.e. has less latency and needs less persistent space). This is because nondeterminism recording by intercepting a single high-level method invocation may capture multiple lower-level sources of nondeterminism, which would otherwise have to be intercepted at a finer granularity at lower levels. In this case, the overhead introduced by recording occurs much less frequently and in turn the total recording overhead decreases. The downside of recording at higher levels, is that it is sometimes not possible or practical to record all nondeterminism sources at such a high level. This multilevel approach aims to dynamically use a best level of multiple recording levels. This multilevel approach can predominantly record at the highest, most efficient applicable level and have the possibility to use the lower level for less common sources of nondeterminism.

In an embodiment, there is a multilevel recorder that is designed to ensure a seamless transition between the levels. When nondeterminism is encountered at a certain level, the recorder checks if a higher level is already capturing and recording the nondeterminism. If the nondeterminism is unhandled by a higher level, the lower level will record the behavior. As part of this strategy, a global flag is set, serving as a signal to instruct the lower level not to redundantly record the same instance of nondeterminism. Consumption of processing time and persistent space by the recording computer is decreased. Accuracy (i.e. fidelity) of the replay computer is increased.

Recording at a higher level such as the Java API level results in recording nondeterminism from multiple system calls in a single recording operation. High level recording provides device independence for portability of the solution. For example, hardware-only record and replay approaches instead rely on hardware specific features, making a solution unportable between distinct computer architectures. The multilevel approach herein enables having both of an efficient higher level mechanism, which can handle most of the nondeterministic inputs to the application, and a lower level approach (e.g. Java native interface, JNI level) as a fallback mechanism that makes the solution more reliable, more accurate, and thus suitable for a wide range of applications.

### 1.0 Example Computer and Java Virtual Machine (JVM)

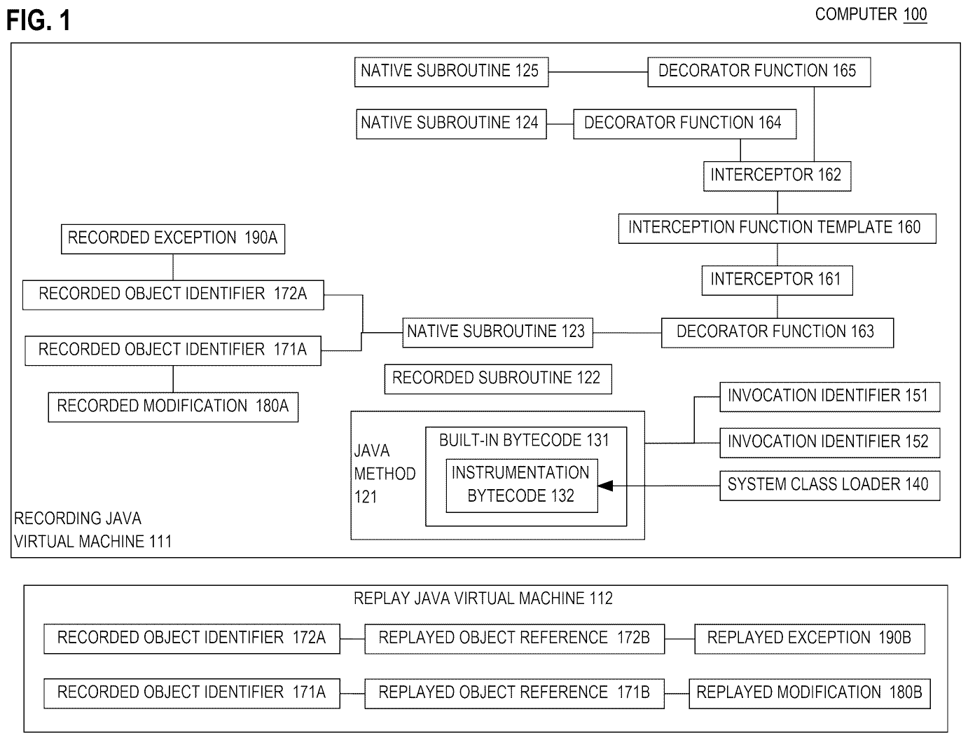

FIG. 1 is a block diagram that depicts example computer 100 for debug of replay of execution of subroutines 121-125 as recorded in java virtual machine (JVM) 111. Nondeterministic execution, arguments, results, and side effects of subroutines 121-125 are recorded by instrumentation at various architectural levels for increased accuracy of instrumented replay. In the shown embodiment, JVMs 111-112 are hosted by a same computer 100. In an embodiment not shown, computer 100 is two computers that are a nondeterminism recording computer and a replay computer that respectively host JVMs 111-112. Any computer herein may be a rack server such as a blade, a mainframe, a virtual machine, or other computing device.

JVMs 111-112 each is middleware that executes a Java application (not shown) that consists of Java classes (not shown). Each Java class already was compiled into a respective class file that contains bytecode that is a set of bytecode instructions that a JVM can interpret to execute the Java methods of the class. A class may have multiple methods that each is a member function of the class. For example, subroutines 121-125 each is part of a same or different respective Java class or, in the case of native subroutines 123-125 as discussed later herein, part of a Java class or not.

Each of subroutines 121-125 was compiled into a distinct respective object code that consists of instructions that a computer may execute. Each of native subroutines 123-125 contains object code (not shown) that consists of machine instructions of an instruction set architecture (ISA) that a central processing unit (CPU) can directly execute. For example, the native object code may have been generated by a C/C++ compiler and may be highly optimized. Herein, native object code is opaque, which means that the approach herein executes, but does not inspect, native object code.

Java method 121 contains bytecode 131 that is a different kind of object code that is a set of bytecode instructions that a JVM may execute by interpretation. For example, interpretation may entail a JVM generating and the CPU executing one or more machine instructions for each bytecode instruction. Depending on the scenario, recorded subroutine 122 may be a native subroutine or a Java method. A native subroutine may or may not implement a native method of a Java class. A subroutine is also referred to as a function. Although the approach herein has different novel respective handling of native subroutines and Java methods, this approach provides a uniform end-user interface that does not require the end user to distinguish between native subroutines and Java methods.

### 1.1 Nondeterminism Log

The approach herein is based on a debug lifecycle that entails a nondeterminism recording phase performed by recording JVM 111 (e.g. on a recording computer) followed by a replay phase performed by replay JVM 112 (e.g. on a replay computer). Because JVMs 111-112 execute in separate respective phases, JVMs 111-112 do not concurrently execute. In this approach, replay JVM 112 accurately repeats the same execution of a Java application that recording JVM 111 performed. This entails recording JVM 111 recording the nondeterministic execution of the Java application, referred to herein as generating a nondeterminism log (not shown), and replay JVM 112 replaying the nondeterminism log to control a repeated execution of the Java application. Herein, a nondeterminism log is also referred to as a recorded log.

Replay enables a software engineer to inspect the operation and transient operating state of the recorded execution of the Java application. There are various environmental factors that can cause the replayed execution to diverge from the recorded execution, and these challenging factors are not well handled by the state of the art. Some example challenges, referred to herein as nondeterminism, for the state of the art are as follows.

JVMs 111-112 do not concurrently execute, which means that an environmental condition such as a transient problem or a boundary condition may occur during nondeterminism recording, but that environmental condition is absent during replay. For example as discussed later herein, recorded exception 190A may be an input/output (I/O) exception that spontaneously occurs during nondeterminism recording but that would not spontaneously occur during replay.

Accuracy of replay herein is unprecedented because values and exceptions generated by the recorded execution are specially recreated in the replay execution so that both executions are identical. For example in this approach, a malfunction in the recorded execution will unconditionally recur in the replay execution, which accelerates debugging and repair of the Java application. In that way, this approach increases the reliability of the repaired Java application and the reliability of the computer that executes the repaired application.

In an embodiment, application execution comprises a sequence of events (not shown). Recording JVM 111 generates a nondeterminism log that consists of accurate records of the execution events, and replay JVM 112 applies the recorded events to control the replayed execution. Example events include lifecycle transitions of a subroutine such as invocation, successful return, or unsuccessful (e.g. recorded exception 190A occurs) return.

For example, recorded subroutines 121 and 123 may execute in recording JVM 111 that records the following sequence of events 1-4: 1) Java method 121 is invoked, 2) Java method 121 successfully returns, 3) native subroutine 123 is invoked, and 4) native subroutine 123 unsuccessfully returns by throwing recorded exception 190A. Recording JVM 111 records each of those events in that sequence even though execution of Java method 121 entails bytecode interpretation and execution of native subroutine 123 does not. In other words, nondeterminism recording herein may occur at different architectural levels in recording JVM 111. In any case, replay enforces the same recorded sequence of events 1-4, which provides unprecedented accuracy of replay.

### 1.2 Java Runtime Environment (JRE) and Java Development Kit (JDK)

Record and replay are based on novel instrumentation herein, and native subroutines 123-125 are instrumented in a different way than Java method 122. In an embodiment, a Java method is instrumented only if the method is built into the Java runtime environment (JRE). Implementations herein may be based on either the JRE or the Java development kit (JDK). A JVM may implement either the JRE or the JDK, but the JRE has a smaller codebase that contains fewer files. Thus, the approach herein consumes less filesystem space than a state of the art JDK debug framework, and that state of the art framework cannot support a Java application that is deployed with the JRE instead of the JDK. Other than the size distinction between the JRE and JDK, discussion of the JRE herein may be implemented with the JDK instead.

Each of JVMs 111-112 contains a JRE that contains a predefined set of built-in Java classes that are highly reusable. For example by definition, a JRE contains Java packages (i.e. predefined sets of Java classes) java.io, java.nio, java.net, and javax.crypto that primarily perform I/O that, as discussed earlier herein, is naturally prone to nondeterminism. In an embodiment, these built-in packages are contained in a file named rt.jar that is a Java archive (jar).

### 1.3 Nondeterminism Instrumentation in Java Architectural Level

Herein, not all Java classes are instrumented, and instrumentation of fewer classes is better for the following reasons. First, nondeterminism recording instrumentation adds computational latency and, because the recorded log is persistent, I/O latency to the execution being recorded. Herein, instrumentation latency may be referred to as drag that may, for example, introduce additional nondeterminism or cause an infrequent software bug not to manifest, which might make recording a timing-sensitive bug impossible. Second, persistent recording space and, if necessary, time spent manually inspecting the recorded log are conserved by less recording of fewer instrumented classes. In those ways, the density (i.e. decreased size) of the recorded log is unprecedented.

For those reasons in the shown embodiment, Java method 121 is a member of a class that is built into the JRE, and built-in bytecode 131 and native subroutines 123-125 also are built into the JRE. However, novel instrumentation bytecode 132 is not built into the JRE and instead is dynamically inserted into built-in bytecode 131. Likewise, instrumentation components 160-162 and novel decorator functions 163-165 are not built into the JRE as discussed later herein.

In an embodiment, an instrumentation class loader is a custom class loader that dynamically inserts instrumentation bytecode 132 into built-in bytecode 131 while the class loader is loading the class that contains Java method 121. In the art: a) a class loader that is not built into the JRE is referred to as a custom class loader; b) the JRE contains various built-in class loaders, including a bootstrap class loader that can only load built-in jars and a default system class loader that can load any jar file; and c) the default system class loader can be replaced with a custom class loader.

In the shown embodiment, system class loader 140 is an instrumentation class loader that replaces the default class loader. In embodiments not shown, system class loader 140 is an instrumentation class loader that does not replace the default class loader, such as an extension class loader or a context (i.e. thread) class loader.

Instrumentation bytecode 132 may record: a) any method lifecycle event of Java method 121 discussed herein such as invocation or return and b) any argument, return value, or thrown exception of Java method 121. Replay injects the same arguments into Java method 121 and returns the same result as was recorded.

A value in Java may have a datatype that is a primitive or is an object (i.e. instance of a Java class). A technical challenge is the identification of an object in a way that supports both of nondeterminism recording and replay. For example: a) java.lang.Object is a Java class that is built into the JRE, b) Object.hashCode is a method that returns an object identifier that is not guaranteed to be unique, and c) System.identityHashCode is a method that returns a unique identifier that can depend on the memory address at which the object is stored. JVMs 111-112 cannot guarantee that a recorded object and its corresponding replay object reside at a same memory address, which means that both copies of the object will have distinct respective identityHashCode values. In other words, state of the art object identification unfortunately would assign both copies of a same object different respective identifiers.

Instrumentation bytecode 132 may record, into the recorded log, some or all of recorded object identifiers 171A-172A that each is the unique memory address or identityHashCode value of a respective recorded object. For example as shown, recorded object identifier 172A uniquely identifies recorded exception 190A. In Java, an exception is an object. In that way, the recorded log can uniquely identify any Java object that is an argument or result of any recorded Java method.

The recorded log also can uniquely identify any Java object that is an argument or result of any recorded native subroutine by operation of instrumentation components 160-165 that, despite having implementations that are structurally very different from instrumentation bytecode 132, are machine code instrumentations that are functionally similar to instrumentation bytecode 132 in ways discussed herein. For example, decorator function 163 may persist recorded object identifiers 171A-172A into the recorded log while native subroutine 123 executes.

### 1.4 Nondeterminism Instrumentation in Native Architectural Level

As discussed earlier herein, events that occur during nondeterminism recording are persisted in the recorded log, but these events are persisted only by instrumentation components 132 and 163-165. Although they do not use the recorded log, instrument components 160-162 are used to configure decorator functions 163-165 as follows.

As discussed earlier herein, the debugging lifecycle has a nondeterminism recording phase followed by a replay phase. In an embodiment, each of both phases begins by configuring instrumentation components 160-165 for native subroutines 123-125 as follows.

Instrumentation components 161 and 163 together operate as a behavioral wrapper around native subroutine 123. An invocation of native subroutine 123 is immediately preceded and immediately followed by operation of instrumentation components 161 and 163. Herein, a distinct decorator function is generated for each recorded native subroutine. As discussed below, native subroutines 124-125 have a same function signature and thus herein, native subroutines 124-125 share interceptor 162.

Each of functions 123-125 and 161-165 has a distinct function signature that each contains: a) a sequence of zero or more parameter datatypes and b) zero (i.e. void) or one return datatype. In this example, there are two distinct function signatures (not shown) that are a first function signature and a second function signature. Functions 123, 161, and 163 have the first function signature. Functions 124-125, 162, and 164-165 have the second function signature.

Because interception function template 160 accepts a variable count of template parameters, interception function template 160 is used to instantiate multiple interceptors 161-162 that have distinct function signatures. The sole use of interception function template 160 is to instantiate interceptors 161-162.

Built into the JRE is the JVM tool interface (JVMTI) that, as discussed later herein, invokes interceptor 161 whenever a Java method attempts to invoke native subroutine 123. Likewise, JVMTI invokes interceptor 162 whenever a Java method attempts to invoke either of native subroutines 124-125. To interceptor 162, JVMTI identifies which of native subroutines 124-125 should be invoked. Interceptor 162 invokes the one of decorator functions 164-165 that corresponds to the one of native subroutines 124-125 that should be invoked. For example when invoked, decorator function 164: a) provides nondeterminism recording and replay functionality as discussed later herein and b) invokes native subroutine 124.

Thus, unlike instrumentation bytecode 132 that is based on insertion of instrumentation into an existing method body, instrumentation components 160-165 do not modify existing object code and instead implement software design patterns, decorator and interceptor, that are noninvasive. Despite this structural distinction between invasive and noninvasive instrumentation, herein instrumentation components 132 and 163-165 have similar nondeterminism recording and replay functionality as discussed later herein.

### 1.5 Example Java Object Lifecycle

Recorded object identifier 171A refers to a recorded object (not shown) that is modified while recording. For example, the recorded log may contain recorded modification 180A that contains all of: a) recorded object identifier 171A that identifies the recorded object, b) the name of the modified field (i.e. data member) of the recorded object, and c) the modified value that replaces an unspecified previous value of the field.

Replay of recorded modification 180A is shown as replayed modification 180B that operates as follows. The recorded object was instantiated (i.e. created) before being modified by recorded modification 180A. Likewise, the corresponding replayed object (not shown) was created before replayed modification 180B can occur.

As discussed earlier herein, a technical challenge is that a recorded object and its corresponding replayed object do not have the same object identifier. Object identifiers 171A-B and 172A-B are retained in an object mapping in replay JVM 112, and this mapping is inspected and dynamically and incrementally populated during replay according to the sequence of records in the recorded log. That is, each record is replayed one after the other.

When any record is replayed that contains recorded object identifier 171A, then recorded object identifier 171A is used as a lookup key into the mapping to cause a mapping hit or a mapping miss. If the mapping does not contain recorded object identifier 171A, then a miss occurs which causes: a) creation of the replayed object and its replayed object reference 171B and b) in the mapping, generating and retaining a key-value pair that contains recorded object identifier 171A as the key and replayed object reference 171B as the value.

Depending on the embodiment, either of components 171A or 180A specifies the Java class of the recorded object, and a mapping miss causes replayed object to be created as an instance of that class. Regardless of whether a mapping hit or miss occurs, the mapping returns replayed object reference 171B for recorded object identifier 171A, and replayed modification 180B is applied to the replayed object. Modifications 180A-B are separately shown for demonstration but actually are identical instances of the same component in separate JVMs 111-112, and that component is a modification record in the recorded log.

In recording JVM 111, native subroutine 123 throws recorded exception 190A, which is recorded in the recorded log. Replay JVM 112 causes same native subroutine 123 to throw corresponding replayed exception 190B. In the shown embodiment, exception replay entails the object mapping retrieving replayed object reference 172B or creating replayed exception 190B. In one example, an exception itself is modifiable, and a recorded modification may contain recorded object identifier 172A to specify either: a) recorded exception 190A contains the field that is modified or b) a different object contains the field that is modified and the modified value is a reference to recorded exception 190A. For example, (b) involves two objects and may twice use the object mapping.

A recorded subroutine may be repeatedly invoked in recording JVM 111, which may be slightly confusing to an end user of replay JVM 112. Although not shown, each recorded subroutine has its own counter in recording JVM 111 to incrementally assign each invocation of, for example, Java method 121 a distinct respective one of invocation identifiers 151-152 that are distinct serial numbers. For increased user ergonomics, replay JVM 112 may present one of invocation identifiers 151-152 during a replayed invocation of Java method 121.

### 1.6 Accelerated Recording and Smaller Recorded Log

For case of demonstration, components 151-152, 171A-172A, 180A, 190A are shown as respectively associated with either Java method 121 or native subroutine 123. In other examples, any of components 151-152, 171A-172A, 180A, 190A may be associated with Java method(s), native subroutine(s), or both. This flexibility facilitates the following diverse call hierarchies.

In an extreme scenario: a) Java method 121 is a member of a class, b) recorded method 122 is a Java method that provides an instance of that class as an argument when invoking native subroutine 123 that invokes Java method 121 as a callback, which causes c) Java method 121 to invoke native subroutine 124. Thus, recorded execution can switch back and forth between Java methods and native subroutines.

As discussed earlier herein, a subroutine is a function that may or may not be a method (i.e. member function), and persistent recording space and instrumentation recording time are decreased by less recording of fewer instrumented subroutines. As follows, further decrease of a count of instrumented methods further decreases recording space and time. As discussed earlier herein, the purpose of special nondeterminism recording and playback herein is to increase replay accuracy by decreasing nondeterminism of replay. As discussed above, one recorded subroutine may call another recorded subroutine, which is multiple recorded subroutines simultaneously nested in a call path, also referred to as a call stack, call tree, or call hierarchy.

Thus during replay, multiple recorded subroutines in a call path imposes a sequence of multiple replay points having a first replay point followed by many subsequent replay points. Enforcement of those subsequent replay points cannot decrease nondeterminism. In other words, all of those subsequent replay points are redundant and, as follows, are dynamically detected as redundant and not recorded into the recorded log, which provides unprecedented recording acceleration by decreased recording drag discussed earlier herein and unprecedented persistent space savings by decreased recorded log size.

### 1.7 Dynamic and Selective Activation and Deactivation of Instrumentation

In an embodiment, instrumentation in each of JVMs 111-112 has: a) a record Boolean condition that indicates whether or not recording is activated and b) a replay Boolean condition that indicates whether or not replaying is activated. Those two conditions are mutually exclusive such that those two conditions will not both be true in a same JVM. If both conditions are false, then all instrumentation is effectively deactivated.

Herein, a Boolean condition is a dynamic global (i.e. singleton, e.g. static scope in Java) instrumentation and may be implemented as a Boolean data field or as a getter Java method that returns a Boolean. As discussed earlier herein, nondeterminism recording and replay may occur at different architectural levels, including a Java level and a native level. In an embodiment discussed later herein, the native architectural level implements each condition as a respective distinct flag with bool primitive datatype, and the Java architecture level wraps each of those flags in a respective distinct getter.

Later herein is instrumentation bool flag isRecord that, when dynamically true, avoids redundant recording when instrumentation components 161-165 and the native architectural level should not (e.g. redundantly) record nondeterminism. Later herein is instrumentation bool flag isReplay that, when dynamically true, causes replay from the recorded log by instrumentation components 161-165 and the native architectural level.

Later herein is instrumentation getter Replay.shouldRecord that avoids redundant recording by dynamically returning true only if instrumentation bytecode 132 and the Java architectural level should record nondeterminism. Later herein is instrumentation getter Replay.shouldReplay that dynamically returns true only if instrumentation bytecode 132 and the Java architectural level should replay from the recorded log.

In an embodiment discussed later herein, bytecodes 131-132 consist of multiple portions such that the body of Java method 121 consists of an alternating sequence of a portion of instrumentation bytecode 132 followed by a portion of built-in bytecode 131 and so forth such that the portions of bytecodes 131-132 are interleaved and execution of Java method 121 alternates back and forth between portions of bytecodes 131-132. Some portions of instrumentation bytecode 132 execute only during replay, and some portions of instrumentation bytecode 132 execute only during nondeterminism recording and only after dynamically testing that Replay.shouldRecord returns true.

That is, each portion of instrumentation bytecode 132 that is designed for nondeterminism recording should, even for a repeated execution, first test Replay.shouldRecord and not execute if false is returned. Thus, any portion of instrumentation bytecode 132 that begins with a test of Replay.shouldRecord will dynamically disable itself if recording would be redundant.

Instrumentation template functions 161-162 may have similar mechanisms of dynamic recording disablement as discussed above and later herein even though, as discussed earlier herein, instrumentation of native subroutines is based on hooks instead of direct insertion into object code. Likewise, instrumentation template functions 161-162 and portions of instrumentation bytecode 132 that execute during replay may dynamically test instrumentation method Replay.shouldReplay, discussed later herein, to conditionally control replay behavior.

In an embodiment discussed later herein: a) instrumentation of native subroutines and of Java methods contain both nondeterminism recording logic and replay logic, b) the instrumentation dynamically tests Replay.shouldRecord and Replay.shouldReplay at respective points in the instrumentation logic, c) Replay.shouldReplay always returns false during nondeterminism recording, and d) Replay.shouldRecord always returns false during replay. In that way, nondeterminism recording logic and replay logic may be combined in a same instrumentation component that dynamically selects its own behavior based on whether the nondeterminism recording phase or the replay phase occurs.

### 2.0 Example Nondeterminism Instrumentation Configuration Process

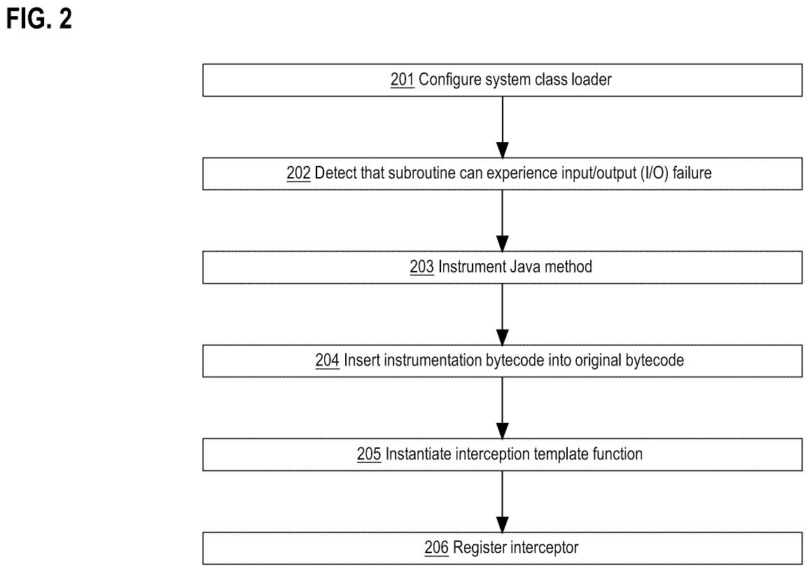

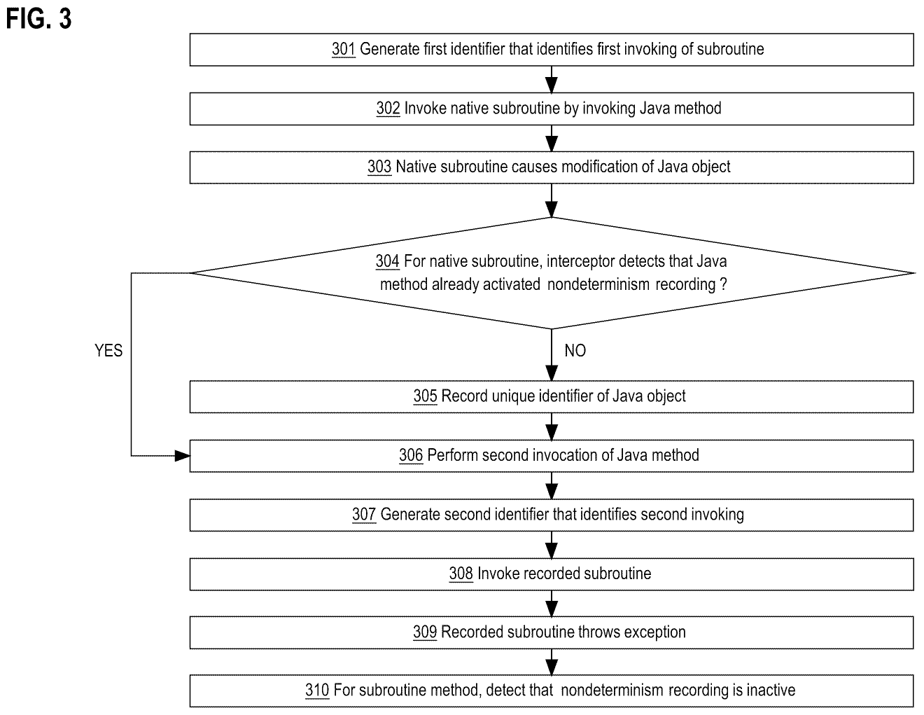

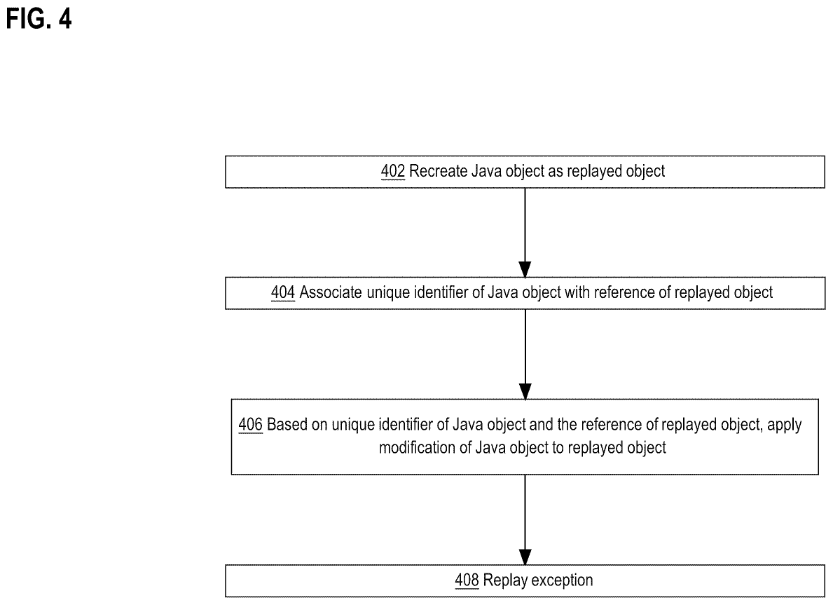

As discussed earlier herein, the debugging lifecycle of computer 100 has a nondeterminism recording phase followed by a replay phase. As discussed above, instrumentation components may be designed to conditionally operate during both phases, and FIG. 2 is a flow diagram that depicts an example instrumenting process that computer 100 may perform for preparatory instrumenting that may occur at the beginning of either phase. FIGS. 3-4 show Java application execution respectively during the nondeterminism recording and replay phases. As follows, the process of FIG. 2 instruments and configures many methods and other subroutines for nondeterminism recording or playback.

As discussed earlier herein, step 201 may configure, to insert instrumentation into recordable classes being loaded, a custom class loader such as a system class loader, an extension class loader, or a context class loader. Which classes are recordable may depend on the implementation as follows, and when and how recordable classes are identified may be implementation dependent. In an embodiment, recordable classes are identified by an expert software developer before the process of FIG. 2 occurs. For example, the human expert may use heuristics such as any of the following rules a-c: a) classes that are not built into the JRE are not recordable, b) native subroutines that are not built into the JRE are not recordable, c) methods are recordable that throw class java.io.IOException (or a subclass) that is built into the JRE.

In an embodiment, recordable classes are automatically identified such as by programed operation of any of above rules a-c. Only in such an automated embodiment, step 202 detects that recorded subroutine 122 can experience input/output (I/O) failure by detecting that the subroutine's signature expressly declares that, for example, an IOException or subclass may be thrown by the subroutine.

In an embodiment, the JRE lazily (i.e. on demand) loads Java classes such that loading some classes may be deferred or entirely avoided, even if the class was manually identified as recordable. In an embodiment, instrumentation is not configured for a class until the class is eventually loaded, which accelerates initial execution of the Java application. In an embodiment, classes and methods or other subroutines that are not identified in the recorded log are not instrumented during the replay phase, even if the class was identified as recordable, which accelerates replayed execution of the Java application.

Step 203 instruments Java method 121 as discussed earlier herein. Step 204 is a sub-step of step 203. Step 204 inserts instrumentation bytecode 132 into original bytecode such as built-in bytecode 131 as discussed earlier herein.

Step 205 generates one or all of interceptors 161-162 by instantiating interception function template 160 as discussed earlier herein. In an embodiment, step 205 generates each interceptor by separately invoking instrumentation native function get_interceptor_for_signature that implements the factory method software design pattern as discussed later herein.

Step 206 registers one or all of interceptors 161-162 with the JRE that, in an embodiment, entails passing the memory address of the interceptor to a separate invocation of native function NativeMethodBind that is built into the JRE as discussed later herein.

### 3.0 Example Accelerated Recording Process for Nondeterminism

FIG. 3 is a flow diagram that depicts an example recording process that recording JVM 111 may perform to generate a nondeterminism log. This example demonstrates dynamically conditional recording across multiple architectural levels as discussed earlier herein.

In this example, steps 301-307 occur during a sequence of method invocations that causes one call path to contain an invocation of native subroutine 123 and multiple invocations of reentrant Java method 121 as follows. Because these various invocations are nested within each other, steps 301-307 all occur during a first invocation of Java method 121.

Step 301 generates a first identifier that identifies a first invocation of a recorded subroutine as discussed earlier herein. For example, first invoking Java method 121 may cause step 301 to persist, in the nondeterminism recording log, an invocation event that contains first invocation identifier 151.

In step 302, the first invocation of Java method 121 is still ongoing, and Java method 121 invokes native subroutine 123. In this example, Java method 121 passes a Java object reference as an argument to native subroutine 123.

In step 303, native subroutine 123 causes a modification to a referenced Java object. In one scenario in step 303, native subroutine 123 assigns a value to a field of the Java object that is referenced by the argument of native subroutine 123. In another scenario in step 303, native subroutine 123 calls back into Java by invoking a method of the Java object that is referenced by the argument and, as a recordable side effect, that method assigns a value to a field of the Java object.

As discussed earlier herein, Java method 121 is in a higher architectural level and native subroutines 123-125 are in a lower level. Step 304 provides acceleration by avoiding lower-level recording when higher-level recording is ongoing. For native subroutine 123 in step 304, interceptor 161 detects whether or not Java method 121 already activated nondeterminism recording. If step 304 detects that, yes, nondeterminism recording already is active, then acceleration is provided by avoiding (i.e. not performing) step 305, in which case step 306 directly follows step 304. Otherwise, step 305 occurs as follows.

Into the recorded log in step 305, decorator function 163 records recorded modification 180A to record the modification performed by above step 303, which includes recording recorded object identifier 171A.

Step 306 performs a second invocation of Java method 121, for which step 307 generates a second identifier that identifies the second invocation. Steps 301 and 307 operate in a similar way, but occur for different respective invocations of Java method 121.

Before step 308, all invocations of Java method 121 return. Step 308 invokes recorded subroutine 122 that may be a Java method or a native subroutine as discussed earlier herein. In step 310, recorded subroutine 122 throws an exception.

Depending on whether recorded subroutine 122 is Java or native, instrumentation bytecode or an interceptor: a) detects that nondeterminism recording is inactive as discussed earlier herein and b) activates nondeterminism recording, including recording recorded object identifier 172A into the recorded log.

### 4.0 Example Replay Process for Increased Accuracy

FIG. 4 is a flow diagram that depicts an example replay process that replay JVM 112 may perform based on a nondeterminism log. This example demonstrates Java object replay as discussed earlier herein. The recorded log may contain unique identifiers of Java objects such as, for example, recorded by step 305 of FIG. 3.

When replay reads recorded object identifier 171A from the recorded log, replay JVM 112 recreates the recorded Java object as a replayed object in step 402. As discussed earlier herein, a technical challenge is that a recorded object and its corresponding replayed object do not have the same object identifier. In an object mapping, step 404 associates the unique identifier of the recorded object with replayed object reference 171B of the replayed object.

As discussed earlier herein, recorded modification 180A contains recorded object identifier 171A. When replay reads recorded modification 180A from the recorded log, corresponding replayed modification 180B occurs for recorded modification 180A as follows. Step 406 uses recorded object identifier 171A as a lookup key into the object mapping to retrieve replayed object reference 171B. Based on recorded object identifier 171A and corresponding replayed object reference 171B, step 406 applies replayed modification 180B to the replayed object that was created by step 402.

As discussed earlier herein, recorded subroutine 122 that may be a Java method or a native subroutine. If the recorded log indicates that recorded object identifier 172A identifies an exception was thrown by one of recorded subroutines 121-125, then step 408 may recreate recorded exception 190A as replayed exception 190B and cause recorded subroutine 122 to throw replayed exception 190B.

### 5.0 Example Java Nondeterminism Instrumentation

For instrumentation of the Java architectural level, below snippets A-B are Java pseudocode (i.e. source code) that are presented for demonstration and are not part of the following implementation that, for example, does not require Java source code. Class java.io.BufferedReader and its methods are built into the JRE. As discussed earlier herein, the JRE is smaller than the JDK because the JRE contains fewer files. For example, actual source code of Java method BufferedReader.readLine is available in the JDK but not in the JRE, and the absence of source code has no impact on techniques herein. The following discussion of source code is for demonstration.

In this example: a) Java method 121 is BufferedReader.readLine, b) below un-instrumented snippet A is source code of Java method 121 before instrumentation, c) demonstrative (i.e. not required in this implementation) compilation of below un-instrumented snippet A would generate built-in bytecode 131 before instrumentation, d) the JRE contains un-instrumented built-in Java components 121 and 131 but not instrumentation bytecode 132, and e) demonstrative compilation of below instrumented snippet B would generate both bytecodes 131-132. Here is un-instrumented snippet A.

String readLine (boolean ignoreLF, boolean[ ] term)
throws IOException
{
return readLine0( ) ;
}

Here is instrumented snippet B.

```
String readLine (boolean ignoreLF, boolean[ ] term)
throws IOException
{
  Replay.setHandleByJDK ( ″BufferedReader: :readLine
(boolean ignoreLF, boolean[ ] term) ″); #1
  String returnVal;
  if (Replay.shouldReplay( ) ) { #2
      IOException e = (IOException)
      Replay.GetReplayException (″BufferedReader-readLine″);
      if (e != null)
          throw e;
      returnVal = Replay.GetReplayValueAsString
  (″BufferedReader-readLine″) ;
  }
  try {
    returnVal = readLine0 (ignoreLF, term) ;
  } catch (IOException e) {
    if (Replay.shouldRecord ( ) ) #3
        Replay.SetReplayException (″BufferedReader-readLine″,
      e) ;
    throw e;
  }
  if (Replay.shouldRecord () ) #4
    Replay.SetReplayValue (″BufferedReader-readLine″,
  returnVal) ;
  replay.unsetHandleByJDK (″BufferedReader: :readLine
  (boolean ignoreLF, boolean [ ] term) ″) ; #5
  return returnVal;
}
```

Above instrumented snippet B contains statements 1-5 that contain #(i.e. hashmark) as shown above. The following are respective operations of statements 1-5.
1. A flag for the lower layer to indicate that all native code that is invoked during this method is handled by the upper layer and should not be redundantly recorded again.
2. If the application is started in replay mode, check if there was an exception thrown by this method during record time. If yes, the exception is deserialized from the recorded log and thrown.
3. If an exception is thrown when reading the line and the application is started in record mode, handle the exception, record it (i.e. serialize it into the recorded log) and throw it.
4. If the application is started in record mode, the read line is recorded.
5. Unset the flag that was set in #1.

### 6.0 Example Native Nondeterminism Instrumentation

For instrumentation of the native architectural level, below are C++ pseudocodes based on JNI and JVMTI as discussed earlier herein. Nondeterministic operating system calls from a Java application can arise from native code, either through JNI or through internal JVM code. In an over-inclusive embodiment, all calls from Java to native code are recorded to guarantee capturing all system call level nondeterminism. This is an over-approximation because there may be some native calls that do not make system calls and do not cause any nondeterministic behavior. In an embodiment, JNI calls that do not make OS system calls are not recorded. For example, a subroutine might have been implemented in JNI solely for acceleration and not for OS usage.

In this example, interceptor 161 invokes decorator function 163 that is responsible for recording input arguments, calling the original function, recording return values, and capturing side effects while recording. During replay, decorator function 163 replicates this data, ensuring accurate replay. Here, side effects are calls from native code back into Java, which can manipulate Java state via JNI. Such side effects may be handled as discussed earlier herein and as follows.

At the JNI level, this embodiment statically infers, from the signature of native subroutine 123, which arguments and return values should be recorded, and the following are two primary heuristics. The first general rule here is to record all return values, because they should be passed back to the caller during replay. The second general rule is to record any arguments which are of reference types. A reference argument could be for any kind of Java object such as an array (i.e. of primitive or non-primitive elements), which native subroutine 123 might manipulate using JNI, which can be recorded so that any side effects made to these references can be replicated during replay.

Native subroutines are intercepted as follows based on registration discussed earlier herein. JVMTI allows a Java application to implement C function NativeMethodBind for registration, which is guaranteed to be invoked upon the first execution of each native subroutine. When invoked by JVMTI during registration, NativeMethodBind accepts a callback function that receives a unique identifier for the native subroutine being intercepted. The identifier is the native subroutine's memory address, allowing this embodiment to redirect native subroutine 123 through interceptor 161. This allows this embodiment to store the memory address of native subroutine 123. Registration occurs only once per native subroutine because the NativeMethodBind invocation occurs only once per native subroutine. The following is pseudocode of a registration function NativeMethodBind, with error handling and edge cases removed for readability.

```
void JNICALL NativeMethodBind (jvmtiEnv *jvmti, JNIEnv *env, jthread
thread, jmethodID method, void *address, void **new_address_ptr)
{
  char *method_signature;
  char *method_name;
  char *class_signature;
  jclass klass;
  jvmti->GetMethodName(method, &method_name, &method_signature,
  null_ptr);
  jvmti->GetMethodDeclaringClass(method, &klass);
  jvmti->GetClassSignature(klass, &class_signature, null_ptr);
  method_address_map[method] = address;
  *new_addres_ptr =
  get_interceptor_for_signature(method_signature, method);
}
```

Above registration function NativeMethodBind may be invoked by JVMTI three times respectively for three native subroutines 123-125. Thus, C++ function get_interceptor_for_signature, which is called above, is invoked three times respectively for three native subroutines 123-125.

Each invocation of C++ function get_interceptor_for_signature generates zero or one instantiation of interception function template 160. For example, because native subroutines 124-125 have the same function signature as discussed earlier herein, if C++ function get_interceptor_for_signature is invoked first for native subroutine 124 and then again for native subroutine 125, then the first invocation of C++ function get_interceptor_for_signature generates instrumentation components 162 and 164, but the second invocation generates only decorator function 165 and reuses interceptor 162.

Pseudocode of C++ function get_interceptor_for_signature is as follows, here simplified for readability. Below, any string literal such as “L;L;[L;)I” is a method descriptor (i.e. mangled method signature) per the Java classfile format that the JVM understands for class loading and constant pools. Reusable method signatures, but not identifiers of individual native subroutines 123-125, are hardcoded in C++ function get_interceptor_for_signature. The following if statements dynamically control which of interceptors 161-162 is instantiated.

```
void *get interceptor_for_signature (const char
*method_signature, jmethodID method)
{
  if (method_signature == ″( ) Z″)
    return (void *) generic_intercept<jboolean>;
  if (method_signature == ″(L;) I″)
    return (void*) generic_intercept<jint, jobject>;
  . . .
  . . .
  . . .
  if (result == ″(L;L; [L; ) I″)
    return (void*) generic_intercept<jint, jobject, jobject,
  jobject>;
}
```

For better readability, the following is streamlined C++ pseudocode of interception function template 160.

```
template <typename T, typename... Args>
T generic_intercept (JNIEnv *env, jobject cls, Args... args)
{
  current_method = get_current_method_id( ) ;
  auto original_function =
  (T (*) (...) ) method_address_map[current_method];
  record_replay_args_before(...);
  T return_value;
  if (!isReplay)
  {
    return_value =
    std::invoke (original_function, env, cls, args...);
  }
  replay_JNI_function_calls(...);
  record_replay_args_after(...);
  handle_return_val<T> (env, return_value);
  return return_value;
}
```

C function SetByteArrayRegion is a JNI function (i.e. native subroutine) that is built into the JRE. In this example. C function SetByteArrayRegion is native subroutine 123. Here is C psuedocode of decorator function 163.

```
void SetByteArrayRegionProxy (JNIEnv *env,
jbyteArray array, jsize start, jsize len, const jbyte *buf)
{
  original_jni_functions->SetByteArrayRegion
  (env, array, start, len, buf) ;
  if (!inInterceptedFunction ∥ !isRecord)
    return;
  if (isRecord)
  {
    record_string_buffer (″SetByteArrayRegion″);
    record_value_buffer ( (void *) &array, sizeof (jbyteArray) );
    record_value_buffer ( (void *) &start, sizeof (jsize) );
    record_value_buffer ( (void *) &len, sizeof (jsize) );
    record_value_buffer ( (void *) buf, len);
  }
}
```

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

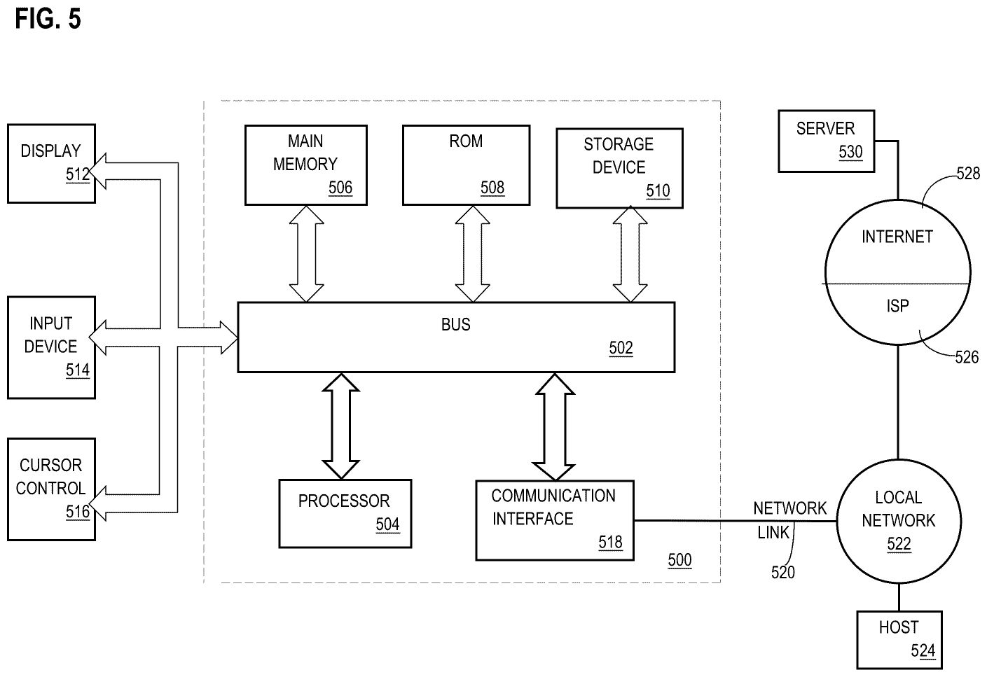

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

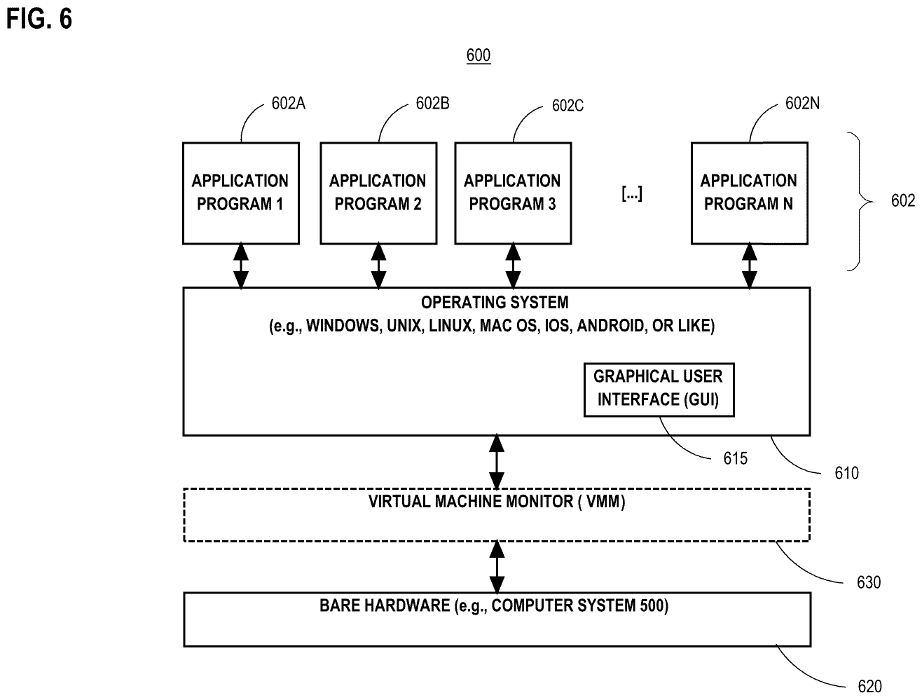

FIG. 6 is a block diagram of a basic software system 600 that may be employed for controlling the operation of computing system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computing system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 600 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
configuring for nondeterminism recording all of: a recorded subroutine, a native subroutine that is not a Java method, and a Java method that invokes the native subroutine;
invoking the native subroutine by invoking the Java method;
detecting, for the native subroutine, that the Java method has activated nondeterminism recording;
invoking, after said invoking the Java method finished, the recorded subroutine; and
detecting, for the recorded subroutine, that nondeterminism recording is inactive.

2. The computer-implemented method of claim 1 wherein said configuring the native subroutine comprises registering an interceptor.

3. The computer-implemented method of claim 2 wherein said registering comprises instantiating an interception function template.

4. The computer-implemented method of claim 2 wherein said invoking the native subroutine is performed by a decorator function that the interceptor invokes.

5. The computer-implemented method of claim 1 wherein:
said invoking the native subroutine comprises a first Java virtual machine recording a unique identifier of a Java object;
the computer-implemented method further comprises a second Java virtual machine performing:
recreating the Java object as a replayed object, and
associating the unique identifier of the Java object with a reference of the replayed object.

6. The computer-implemented method of claim 5 wherein:
said invoking the native subroutine comprises the native subroutine causing a modification of the Java object;
the computer-implemented method further comprises the second Java virtual machine applying, based on the unique identifier of the Java object and the reference of the replayed object, the modification of the Java object to the replayed object.

7. The computer-implemented method of claim 1 wherein:
the Java method is built into a Java virtual machine;
said configuring the Java method comprises instrumenting the Java method.

8. The computer-implemented method of claim 7 wherein:
the Java method consists of first bytecode;
said instrumenting the Java method comprises inserting second bytecode into said first bytecode.

9. The computer-implemented method of claim 1 wherein:
the computer-implemented method further comprises detecting that a particular method can experience an input/output (I/O) failure;
the particular method is selected from a group comprising the recorded subroutine, the native subroutine, and the Java method;
said configuring for nondeterminism recording the particular method is responsive to said detecting that the particular method can experience the I/O failure.

10. The computer-implemented method of claim 1 wherein said configuring the Java method comprises configuring a system class loader.

11. The computer-implemented method of claim 1 wherein:
the computer-implemented method further comprises a particular method throwing an exception in a first Java virtual machine;
the particular method is selected from a group comprising the recorded subroutine, the native subroutine, and the Java method;
the computer-implemented method further comprises replaying the exception in a second Java virtual machine.

12. The computer-implemented method of claim 1 wherein:
said invoking the Java method is a first invoking;
said first invoking comprises generating a first identifier that identifies said first invoking;
the first identifier is not based on a timestamp;
the computer-implemented method further comprises second invoking the Java method;
said second invoking comprises generating a second identifier that identifies said second invoking.

13. One or more non-transitory computer-readable media storing instructions that, when executed by one or more processors, cause:
configuring for nondeterminism recording all of: a recorded subroutine, a native subroutine that is not a Java method, and a Java method that invokes the native subroutine;
invoking the native subroutine by invoking the Java method;
detecting, for the native subroutine, that the Java method has activated nondeterminism recording;
invoking, after said invoking the Java method finished, the recorded subroutine; and
detecting, for the recorded subroutine, that nondeterminism recording is inactive.

14. The one or more non-transitory computer-readable media of claim 13 wherein said configuring the native subroutine comprises registering an interceptor.

15. The one or more non-transitory computer-readable media of claim 13 wherein:
said invoking the native subroutine comprises a first Java virtual machine recording a unique identifier of a Java object;
the instructions further cause a second Java virtual machine performing:
recreating the Java object as a replayed object, and
associating the unique identifier of the Java object with a reference of the replayed object.

16. The one or more non-transitory computer-readable media of claim 13 wherein:
the Java method is built into a Java virtual machine;
said configuring the Java method comprises instrumenting the Java method.

17. The one or more non-transitory computer-readable media of claim 13 wherein:
the instructions further cause detecting that a particular method can experience an input/output (I/O) failure;
the particular method is selected from a group comprising the recorded subroutine, the native subroutine, and the Java method;
said configuring for nondeterminism recording the particular method is responsive to said detecting that the particular method can experience the I/O failure.

18. The one or more non-transitory computer-readable media of claim 13 wherein said configuring the Java method comprises configuring a system class loader.

19. The one or more non-transitory computer-readable media of claim 13 wherein:
the instructions further cause a particular method throwing an exception in a first Java virtual machine;
the particular method is selected from a group comprising the recorded subroutine, the native subroutine, and the Java method;
the instructions further cause replaying the exception in a second Java virtual machine.

20. The one or more non-transitory computer-readable media of claim 13 wherein:
said invoking the Java method is a first invoking;
said first invoking comprises generating a first identifier that identifies said first invoking;
the first identifier is not based on a timestamp;
the instructions further cause second invoking the Java method;
said second invoking comprises generating a second identifier that identifies said second invoking.
